(19) United States
(12) Patent Application Publication
(10) Pub. No.: US 2026/0149191 A1
(43) Pub. Date: May 28, 2026

(54) INSULATION DISPLACEMENT TERMINAL FOR CONTACTING AN INSULATED WIRE

(71) Applicant: TE Connectivity Solutions GmbH, Schaffhausen (CH)

(72) Inventors: Sundareshan MALAVALLI DASAPRAKASH, Schaffhausen (CH); Rakesh RAMACHANDRANNAIR SREELEKHA, Schaffhausen (CH)

(21) Appl. No.: 19/399,975

(22) Filed: Nov. 25, 2025

(30) Foreign Application Priority Data
Nov. 28, 2024 (IN) 202441093104

(51) Int. Cl. H01R 4/2452

(52) U.S. Cl. CPC H01R 4/2452

(57) ABSTRACT

An electrical terminal for contacting a conductive core of an insulated wire includes first and second insulation displacement slots for receiving the insulated wire thus effecting insulation displacement termination of the received wire, wherein the first insulation displacement slot is spaced apart from the second insulation displacement slot. First and second support walls each extend from the first insulation displacement slot to the second insulation displacement slot. At least one of the first and second support wall is at least sectionally arched away from the respective other support wall.

### CROSS REFERENCE TO RELATED APPLICATIONS

This application claims the benefit of IN Application No. 202441093104, filed 28 Nov. 2024, the subject matter of which is herein incorporated by reference in its entirety.

### BACKGROUND OF THE INVENTION

The subject matter herein relates to an electrical terminal, in particular an insulation displacement terminal for contacting a conductive core of an insulated wire. Moreover, the subject matter herein relates to a connection assembly having an electrical terminal and an insulated wire.

Insulation displacement terminals are used as a quick and efficient means for terminating insulated wires, cables and other types of electrical lines formed by an inner conductive core and an outer insulative layer. The insulation displacement terminals usually comprise slots formed by e.g., cutting edges or sharpened corners. By pressing the electrical lines into these slots, their outer insulative layer is pierced, granting access to their inner conductive core. The time and effort for stripping the conductive core of the insulative layer can thus be saved.

In order to contact the inner conductive core reliably, the insulation displacement terminal has to provide and maintain a sufficient normal force. However, insulation displacement terminals known in the art often lack the capability of exerting a sufficient contacting force. Furthermore, known insulation displacement terminals have a tendency of losing their contacting force over time. Both of these flaws are detrimental to the reliability of the known insulation displacement terminals.

There is a need to provide improved means for insulation displacement termination, which allow for a reliable contacting of a conductive core of an insulated wire.

### BRIEF DESCRIPTION OF THE INVENTION

In one embodiment, an electrical terminal for contacting a conductive core of an insulated wire is provided including a first and second insulation displacement slot each for at least partly receiving therein the insulated wire thus effecting insulation displacement termination of the received wire, wherein the first insulation displacement slot is spaced apart from the second insulation displacement slot. The electrical terminal further comprises a first and second support wall each extending from the first insulation displacement slot to the second insulation displacement slot, wherein the second support wall is arranged opposite of the first support wall with respect to the first and second insulation displacement slot, and wherein at least one of the first and second support wall is at least sectionally arched away from the respective other support wall.

Herein, insulation displacement termination refers to the above-described process of displacing and piercing an insulative layer of the received wire such that the conductive core of the received wire is contacted by the electrical terminal, in particular by its support walls. After all, it is the first and second support wall that jointly define the first and second insulation displacement slot, since the support walls extend between the insulation displacement slots, while being arranged on opposite sides of the insulation displacement slots. In other words, the first and second support wall each reaches, stretches or ranges from the first insulation displacement slot to the second insulation displacement slot, while also being mutually separated by the first and second insulation displacement slot.

As such, the first and second support wall must be able to withstand any mechanical loads resulting from the insulation displacement termination. Moreover, the first and second support wall have to provide and keep the necessary contacting force. Advantageously, the at least sectionally arched support wall exhibits an increased stiffness and rigidity. Therefore, the at least sectionally arched support wall is less likely to give in to the mechanical loads and is less prone to material creep, when the insulated wire is received in the first and second insulation displacement slot. Thereby, the total contacting force exerted by the electrical terminal is increased and remains high compared to known insulation displacement terminals with straight, not-arched support walls. Consequently, the electrical terminal provides improved means for insulation displacement termination, which allows for a reliable contacting of a conductive core of an insulated wire.

In an embodiment, a connection assembly is provided including an electrical terminal, such as described above, and an electrical wire formed by a conductive core surrounded by an insulative layer, wherein the electrical wire is at least partly received in the first and second insulation displacement slot, and wherein the first and second support wall each at least partly pierces through the insulative layer and each contacts the conductive core. In particular due to the at least sectionally arched support wall, the contacting between the conductive core and the support walls is improved, resulting in a high, long-term reliability of the whole connection assembly.

The subject matter herein can be further improved by the following features, which are independent of each other with respect to their technical effects and which can be combined arbitrarily.

According to a possible embodiment of the electrical terminal, each of the first and second support wall may be at least sectionally arched away from the respective other support wall. That is, the first support wall is at least sectionally arched away from the second support wall and vice versa. By having both support walls at least sectionally arched, the stiffness and rigidity of the entire electrical terminal can be increased, since the support walls not only better withstand un-desired deformation, but also sustain one another.

For example, the first support wall may be arched away from the second support wall in that it comprises a first curved region with a vertex flanked by two ends, wherein the vertex of the first curved region is farther from the second support wall compared to the ends of the first curved region. Analogously, the second support wall may be arched away from the first support wall in that it comprises a second curved region also with a vertex flanked by two ends, wherein the vertex of the second curved region is farther from the first support wall compared to the ends of the second curved region.

A simplified geometry of the electrical terminal can be obtained when the first and second support wall are configured symmetrical with respect to the first and second insulation displacement slot. In particular, the first and second support wall may be mirrored with respect to the first and second insulation displacement slot. Accordingly, the first curved region and the second curved region may be mutually symmetrical.

According to another possible embodiment, the first curved region and/or the second curved region may be obtained by means of punching or embossing. That is, the first support wall may comprise a first punched section, wherein the first support wall is arched at the first punched section. Likewise, the second support wall may comprise a second punched section, wherein the second support wall is arched at the second punched section. Further, the electrical terminal may be a stamped-and-bent part. These all represent cost effective ways of manufacturing the electrical terminal.

Optionally, the first punched section may be arranged centrally on the first support wall and/or the second punched section may be arranged centrally on the second support wall. That is, the first support wall may comprise a first middle section where the first punched section is located, while the second support wall may comprise a second middle section where the second punched section is located. In particular, the middle of the respective punched section may coincide with the middle of the corresponding support wall. Further, the first punched section and the first middle section may coincide just like the second punched section and the second middle section may coincide.

Herein, the middle may be defined as a geometric center, a center of gravity, a center of sym-metry, a circumcenter or a bounding box center. The central arrangement of the first punched section and/or the second punched section results in a more equal distribution of the contacting force between a first part of the insulated wire that is received in the first insulation displacement slot and a second part of the insulated wire that is received in the second insulation displacement slot.

According to another possible embodiment, the electrical terminal may comprise a base section interconnecting the first and second support wall. In particular, the base section may be integrally connected with each of the first and second support wall, in particular with each of the first and second middle section. Herein, the first and second support wall may each extend at an angle to the base section resulting in a compact, space-saving design of the electrical terminal. For example, the electrical terminal may comprise a U-shaped profile where the base section serves as a fundament for the electrical terminal.

Moreover, the electrical terminal may comprise a joint section such as a pin-shaped contact, a socket-shaped contact, a crimp barrel, a soldering pad, a welding pad or the like. The joint section may also be integrally connected with the base section. Alternatively, the first and second support wall may be interconnected directly without any base section in between them. In other words, the electrical terminal may comprise a V-shaped profile. In that case, the joint section may be integrally connected with the first and/or second support wall, in particular with the first and/or second middle section.

Optionally, the electrical terminal may comprise a receiving section between the first and second insulation displacement slot. In other words, the second insulation displacement slot may be arranged opposite of the first insulation displacement slot with respect to the receiving section. As such, the receiving section may serve for at least partly accommodating therein an intermediate part of the insulated wire. Herein, the intermediate part of the insulated wire is received neither in the first insulation displacement slot nor in the second insulation displacement slot. Rather, the intermediate part of the insulated wire connects the above-mentioned first part of the insulated wire to the above-mentioned second part of the insulated wire.

Together with the base section, the first and second support wall may delimit the receiving section. Moreover, the first and second support wall may be separated from each other by the receiving section. Further, the first and/or second support wall may be arched outwards with respect to the receiving section.

In order to facilitate the above-mentioned piercing of the insulative layer, the electrical terminal may be provided with one or more cutting edges. These cutting edges may form an oblique guiding slope for guiding the insulated wire into the corresponding insulation displacement slot. Further, these cutting edges may form a vertical blade that is sharp enough to cut through the insulative layer without the necessity of excessive force.

Particularly, the first and second support wall may each comprise a first cutting edge and a second cutting edge, wherein the first cutting edge of the first support wall and the first cutting edge of the second support wall form the first insulation displacement slot, and wherein the second cutting edge of the first support wall and the second cutting edge of the second support wall form the second insulation displacement slot.

According to another embodiment, the electrical terminal may be provided with one or more side lugs. These side lugs may be configured as flap-like structures that are directed towards the insulation displacement slots and stem against the received wire. In particular, the first support wall may comprise a first side lug and a second side lug each integrally connected to the above-mentioned first middle section at an angle. Likewise, the second support wall may also comprise a first side lug and a second side lug each integrally connected to the above-mentioned second middle section at an angle. Moreover, the first side lug of the first side wall and the first side lug of the second side wall may be bent towards the first insulation displacement slot, while the second side lug of the first support wall and the second side lug of the second support wall may be bent towards the second insulation displacement slot.

On the first support wall, its first side lug may form its first cutting edge and its second side lug may form its second cutting edge. Analogously, on the second support wall, its first side lug may form its first cutting edge and its second side lug may form its second cutting edge. In particular, each side lug may be configured to be self-supporting and may comprise a proximal end as well as a distal end. Herein, the respective proximal end is integrally connected to the corresponding middle section, while the respective distal end forms the corresponding cutting edge. Thereby, the size and angle of the side lugs can be used for defining the dimensions of the insulation displacement slots.

As already mentioned above, each side lug may be integrally connected to its corresponding middle section at an angle. Furthermore, each side lug may be bent towards its corresponding insulation displacement slot. In other words, there may be an angle and bend between each side lug and the rest of its corresponding support wall, in particular between each side lug and its corresponding middle section. The electrical terminal may comprise at least one stiffening bead extending in that bend between one of the side lugs and its corresponding middle section. In particular, the at least one stiffening bead may extend perpendicular to a fold of that bend and thus form a diagonal brace between the side lug and the middle section. Thereby, the at least one stiffening bead can structurally reinforce the side lug and prevent it from giving in to the above-mentioned mechanical loads resulting from the insulation displacement termination.

Optionally, the electrical terminal may comprise a plurality of such stiffening beads, each one extending in a different bend between one of the side lugs and its corresponding middle section. This allows the above-explained structural reinforcement to be implemented at multiple locations. In particular, the electrical terminal may comprise, for each side lug, one stiffening bead, thus four in total, two on each support wall. It is, however, also conceivable that each side lug comprises multiple parallel stiffening beads.

According to another possible embodiment, the stiffening beads located on the first support wall may form an arc with the first punched section, while the stiffening beads located on the second support wall may form an arc with the second punched section. In particular, the arcs formed this way may be smooth and continuous, without any gaps. Hence, the above-explained structural reinforcement provided by the stiffening beads can be chained with the increased stiffness and rigidity of the punched sections. Thereby, the stiffness and rigidity of the entire first and second support wall, or at least a majority of the entire first and second support wall, is increased.

According to a possible embodiment of the connection assembly, at least one of the first and second support wall of the electrical terminal is at least sectionally straight, all the while the electrical wire is received in the first and second insulation displacement slot. That means, the originally arched support wall is straightened due to the above-mentioned mechanical loads ensuing the insulation displacement termination. As such, the straightened support wall can exert a greater reactive force on the conductive core compared to known insulation displacement terminals with straight, not-arched support walls that tend to arc inwardly and weaken when receiving the electrical wire.

The connection assembly may optionally comprise a housing for accommodating the electrical terminal therein. The housing may comprise inner walls against which the first and second support wall of the electrical terminal rest. In particular, the first and second support wall may at least sectionally rest flatly against the inner walls of the housing. Thereby, the electrical terminal can be stably seated within the housing.

In the following, exemplary embodiments of the invention are described with reference to the drawings. The shown and described embodiments serve explanatory purposes only. The combination of features shown in the embodiments may be changed according to the foregoing description. For example, a feature which is not shown in an embodiment but described above may be added if the technical effect associated with this feature is beneficial for a particular application, and vice versa (a feature shown as part of an embodiment may be omitted as described above if the technical effect associated with this feature is not needed in a particular application).

### BRIEF DESCRIPTION OF THE DRAWINGS

In the drawings, elements that correspond to each other with respect to function and/or structure have been provided with the same reference numeral.

FIG. 1 shows a schematic perspective view of an electrical terminal according to an exemplary embodiment;

FIG. 2 shows a schematic perspective view of the electrical terminal according to another exemplary embodiment;

FIG. 3 shows a top view of the electrical terminal from FIG. 2;

FIG. 4 shows a bottom view of the electrical terminal from FIG. 2;

FIG. 5 shows a side view of the electrical terminal from FIG. 2;

FIG. 6 shows a front view of the electrical terminal from FIG. 2;

FIG. 7 shows a front view of the electrical terminal according to another exemplary embodiment;

FIG. 8. shows a top view of a connection assembly with the electrical terminal from FIG. 2.

### DETAILED DESCRIPTION OF THE INVENTION

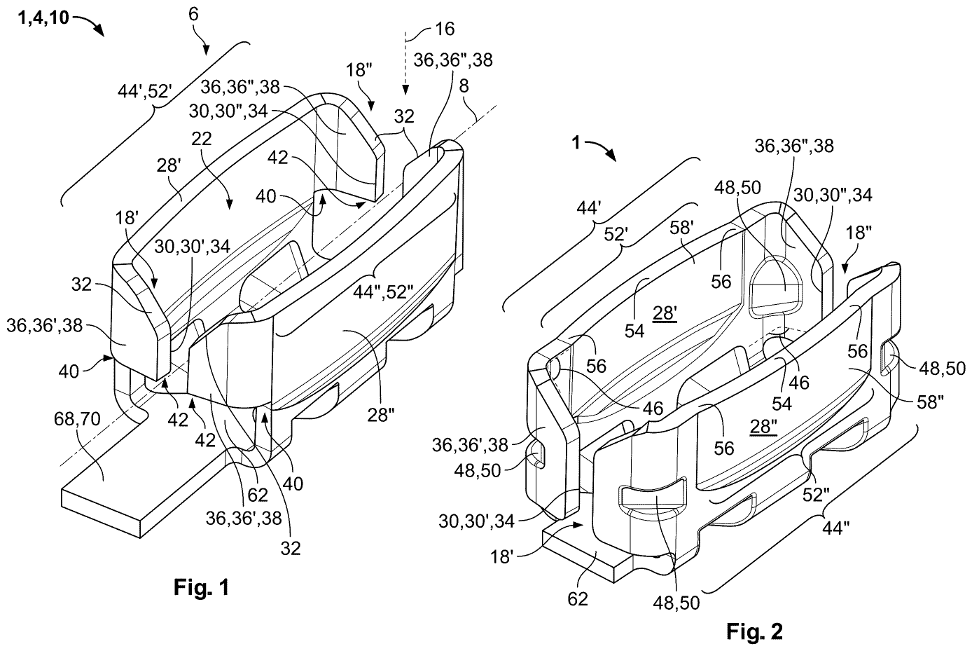

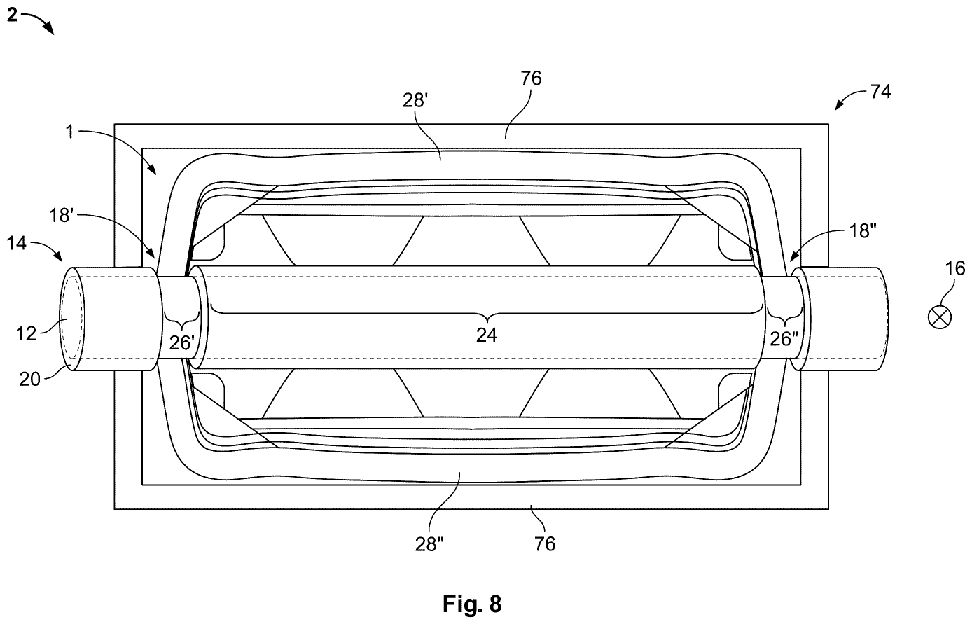

First, the structure of the electrical terminal 1 is explained with reference to the exemplary embodiments shown in FIGS. 1 to 7. Thereafter, the structure of the connection assembly 2 is explained with reference to the exemplary embodiment shown in FIG. 8.

As can be seen in FIG. 1, the electrical terminal 1 may be a stamped-and-bent part 4 made of sheet metal, for example copper, aluminum or an alloy thereof. The electrical terminal 1 comprises a cuboid body 6, the cuboid body 6 extending along a longitudinal axis 8. As such, the electrical terminal 1 is configured as an insulation displacement terminal 10 for contacting a conductive core 12 of an insulated wire 14 (see FIG. 8). The insulated wire 14 is pressed into the electrical terminal 1 along a pressing direction 16 that is perpendicular to the longitudinal axis 8.

In particular, the electrical terminal 1 comprises a first insulation displacement slot 18′ and a second insulation displacement slot 18″ extending perpendicular to the longitudinal axis 8. Both insulation displacement slots 18′, 18″ serve for at least partly receiving therein the insulated wire 14, thus effecting insulation displacement termination of the received wire 14. Herein, insulation displacement termination refers to a process where an insulative layer 20 of the received wire 14 is displaced and pierced such that the conductive core 12 of the received wire 14 is contacted by the electrical terminal 1. Said process can take place when the insulated wire 14 is pressed into the first and second insulation displacement slot 18′, 18″ along the pressing direction 16.

As can further be seen in FIG. 1, the first insulation displacement slot 18′ is spaced apart from the second insulation displacement slot 18″. In particular, the first insulation displacement slot 18′ is aligned with the second insulation displacement slot 18″ along the longitudinal axis 8. Further, the electrical terminal 1 may comprise a receiving section 22 between the first and second insulation displacement slot 18′, 18″. In other words, the second insulation displacement slot 18″ may be arranged opposite of the first insulation displacement slot 18′ with respect to the receiving section 22. Hence, the receiving section may serve for at least partly accommodating therein an intermediate part 24 of the insulated wire 14 (see FIG. 8).

Herein, the intermediate part 24 of the insulated wire 14 is received neither in the first insulation displacement slot 18′ nor in the second insulation displacement slot 18″. Rather, the intermediate part 24 of the insulated wire 14 connects a first part 26′ of the insulated wire 14 that is received in the first insulation displacement slot 18′ to a second part 26″ of the insulated wire 14 that is received in the second insulation displacement slot 18″.

The electrical terminal 1 further comprises a first support wall 28′ and a second support wall 28″, each extending from the first insulation displacement slot 18′ to the second insulation displacement slot 18″. In other words, the first and second support wall 28′, 28″ each reaches, stretches or ranges from the first insulation displacement slot 18′ to the second insulation displacement slot 18″. Herein, the second support wall 28″ is arranged opposite of the first support wall 28′ with respect to the first and second insulation displacement slot 18′, 18″ as well as with respect to the receiving section 22.

As can be seen in FIG. 1, the first and second support wall 28′, 28″ jointly define each of the first and second insulation displacement slot 18′, 18″. Moreover, the first and second support wall 28′, 28″ may delimit the receiving section 22. In turn, the first and second insulation displacement slot 18′, 18″ as well as the receiving section 22 separate the first support wall 28′ from the second support wall 28″. As can be seen in FIG. 3, the first and second support wall 28′, 28″ are configured symmetrical with respect to the first and second insulation displacement slot 18′, 18″. In particular, the first and second support wall 28′, 28″ may be mirrored with respect to the first and second insulation displacement slot 18′, 18″.

In order to facilitate the above-mentioned piercing of the insulative layer 20, the electrical terminal 1 may be provided with one or more cutting edges 30. These cutting edges 30 may form an oblique guiding slope 32 for guiding the insulated wire 14 into the corresponding insulation displacement slot 18′, 18″. Further, the cutting edges 30 may form a vertical blade 34 that is sharp enough to cut through the insulative layer 20 without the necessity of excessive force.

In particular, the first and second support wall 28′, 28″ may each comprise a first cutting edge 30′ and a second cutting edge 30″, wherein the first cutting edge 30′ of the first support wall 28′ and the first cutting edge 30′ of the second support wall 28″ jointly form the first insulation displacement slot 18′, while the second cutting edge 30″ of the first support wall 28′ and the second cutting edge 30″ of the second support wall 28″ jointly form the second insulation displacement slot 18″.

As can be seen in FIG. 3, the cutting edges 30, 30′, 30″ may be arranged on side lugs 36 of the electrical terminal 1. These side lugs 36 may be configured as flap-like structures 38 that are directed towards the respective insulation displacement slot 18′, 18″ and stem against the received wire 14. Each side lug 36 may be configured self-supporting and may comprise a proximal end 40 as well as a distal end 42 (see FIG. 1).

In particular, the first support wall 28′ may comprise a first side lug 36′ forming its first cutting edge 30′ and a second side lug 36″ forming its second cutting edge 30″. Likewise, the second support wall 28″ may comprise a first side lug 36′ forming its first cutting edge 30′ and a second side lug 36″ forming its second cutting edge 30″. Herein, the respective distal end 42 forms the corresponding cutting edge 30, 30′, 30″.

Moreover, the first side lug 36′ of the first support wall 28′ and the first side lug 36′ of the second support 28″ may be bent or folded towards the first insulation displacement slot 18′, while the second side lug 36″ of the first support wall 28′ and the second side lug 36″ of the second support wall 28″ may be bent or folded towards the second insulation displacement slot 18″. Herein, the first side lugs 36′ are not exactly parallel to each other, but rather extend at a slight angle to each other. Similarly, the second side lugs 36″ extend at a slight angle to each other, instead of being exactly parallel to each other. This results in the first and second insulation displacement slot 18′, 18″ being substantially wedge-shaped. In other words, the first and second insulation displacement slot 18′, 18″ become narrower towards the receiving section 22 (see FIG. 3). In particular, the first and second insulation displacement slot 18′, 18″ are narrowest at the respective cutting edges 30, 30′, 30″.

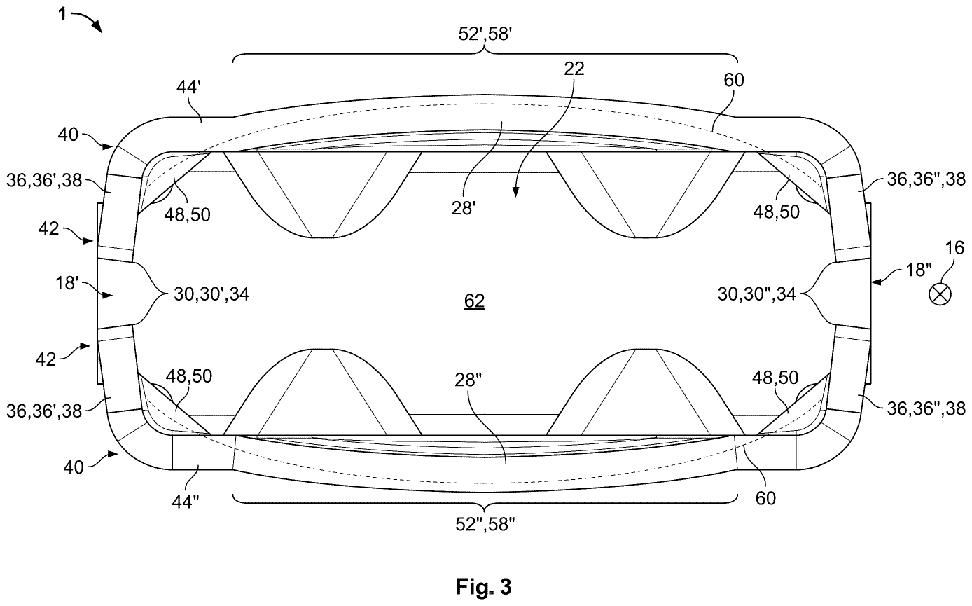

As can further be seen in FIG. 3, the first and second side lug 36′, 36″ of the first support wall 28′ are each integrally connected to a first middle section 44′ of the first support wall 28′. Likewise, the first and second side lug 36′, 36″ of the second support wall 28″ are each integrally connected to a second middle section 44″ of the second support wall 28″. In particular, the respective proximal end 40 is integrally connected to the corresponding middle section 44′, 44″. Due to the above-mentioned bend or fold, each side lug 36, 36′, 36″ extends at an angle 46 to its corresponding middle section 44′, 44″ (see FIG. 2).

In the angle 46 between each side lug 36, 36′, 36″ and its corresponding middle section 44′, 44″, the electrical terminal 1 may comprise stiffening beads 48 (see FIG. 2). These stiffening beads 48 may be obtained by means of punching or embossing. As such, the stiffening beads 48 may extend perpendicular to the insulation displacement slots 18′, 18″. Hence, each stiffening bead 48 provides structural reinforcement to the electrical terminal 1 by forming a diagonal brace 50 between the respective side lug 36, 36′, 36″ and the corresponding middle section 44′, 44″ (see FIG. 3).

Further structural reinforcement to the electrical terminal 1 is achieved by having at least one of the first and second support wall 28′, 28″ at least sectionally arched away from the respective other support wall 28″, 28′. As can be seen in FIG. 3, both the first and second support wall 28′, 28″ may be at least sectionally arched away from the respective other support wall 28″, 28′. That is, the first support wall 28′ is at least sectionally arched away from the second support wall 28″ and vice versa. Moreover, the first and second support wall 28′, 28″ are arched outwards with respect to the receiving section 22.

As can be seen in FIG. 2, the first support wall 28′ may be arched away from the second support wall 28″ in that it comprises a first curved region 52′ with a vertex 54 flanked by two ends 56, wherein the ends 56 of the first curved region 52′ are closer to the second support wall 28″ compared to the vertex 54 of the first curved region 52′. Analogously, the second support wall 28″ may be arched away from the first support wall 28′ in that it comprises a second curved region 52″ also with a vertex 54 flanked by two ends 56, wherein the vertex 54 of the second curved region 52″ is farther from the first support wall 28′ compared to the ends 56 of the second curved region 52″. Herein, the first curved region 52′ and the second curved region 52″ may be mutually symmetrical (see FIG. 3).

Similar to the stiffening beads 48, the first curved region 52′ and the second curved region 52″ may be obtained by means of punching or embossing. That is, the first support wall 28′ may comprise a first punched section 58′, wherein the first support wall 28′ is arched at the first punched section 58′. Likewise, the second support wall 28″ may comprise a second punched section 58″, wherein the second support wall 28″ is arched at the second punched section 58″.

As can be seen in FIG. 3, the first punched section 58′ may be arranged centrally on the first support wall 28′ and the second punched section 58″ may be arranged centrally on the second support wall 28″. In particular, the middle of the respective punched section 58′, 58″ may coincide with the middle of the corresponding support wall 28′, 28″. That is, the first punched section 58′ is located at the above-mentioned first middle section 44′, while the second punched section 58″ is located at the above-mentioned second middle section 44″. Optionally, the first punched section 58′ and the first middle section 44′ may coincide just like the second punched section 58″ may coincide with the second middle section 44″.

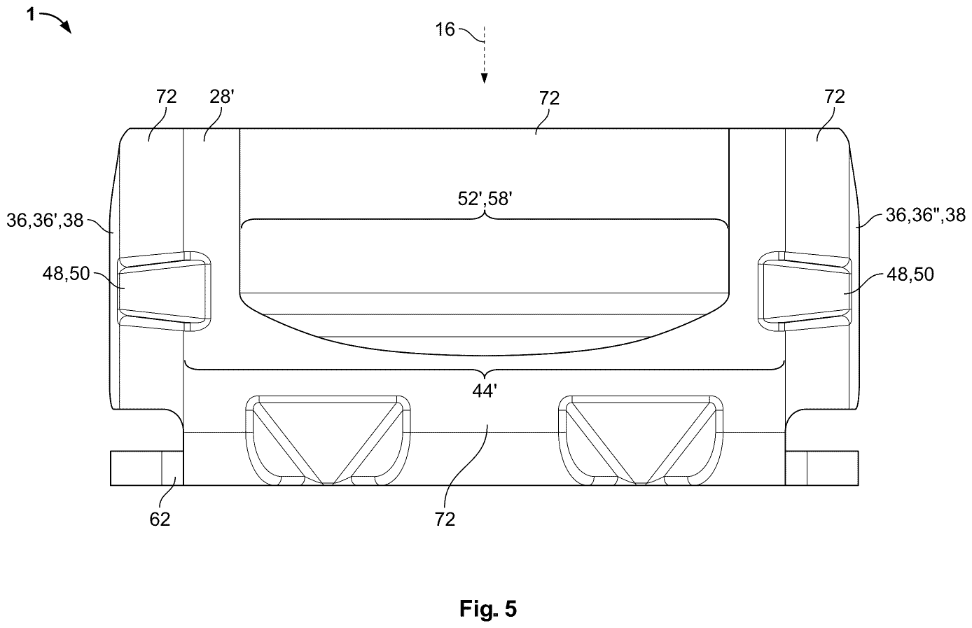

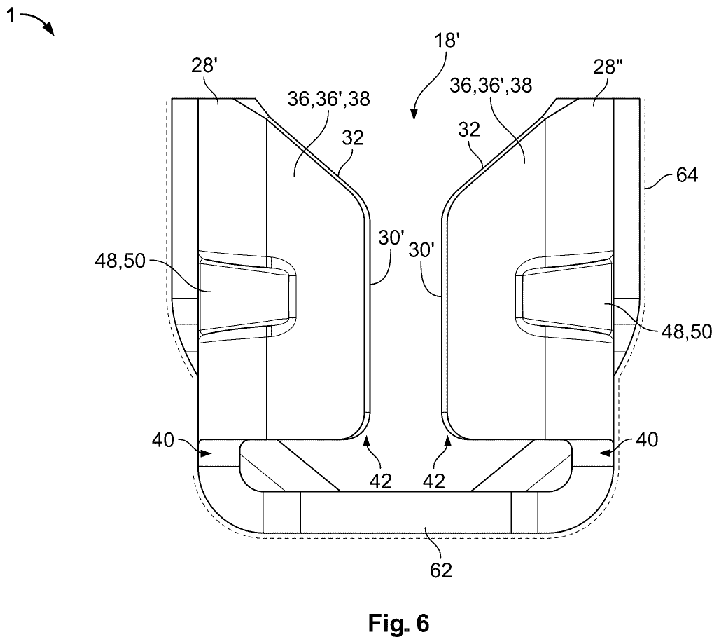

As can further be seen in FIG. 3, the stiffening beads 48 located on the first support wall 28′ may form an arc 60 with the first punched section 58′, while the stiffening beads 48 located on the second support wall 28″ may form an arc 60 with the second punched section 58″. In particular, the arcs 60 formed this way may be smooth and continuous, without any gaps. In FIGS. 5 and 6, it is shown that the stiffening beads 48 and the punched sections 58′, 58″ may be arranged at the same height.

As can be seen in FIG. 6, the electrical terminal 1 may comprise a base section 62 interconnecting the first and second support wall 28′, 28″. In particular, the base section 62 may be integrally connected with each of the first and second middle section 44′, 44″. Moreover, the first and second support wall 28′, 28″ may each extend at an angle to the base section 62, resulting in a U-shaped profile 64 in a plane essentially perpendicular to the longitudinal axis 8. Herein, the base section 62 serves as a fundament for the electrical terminal 1.

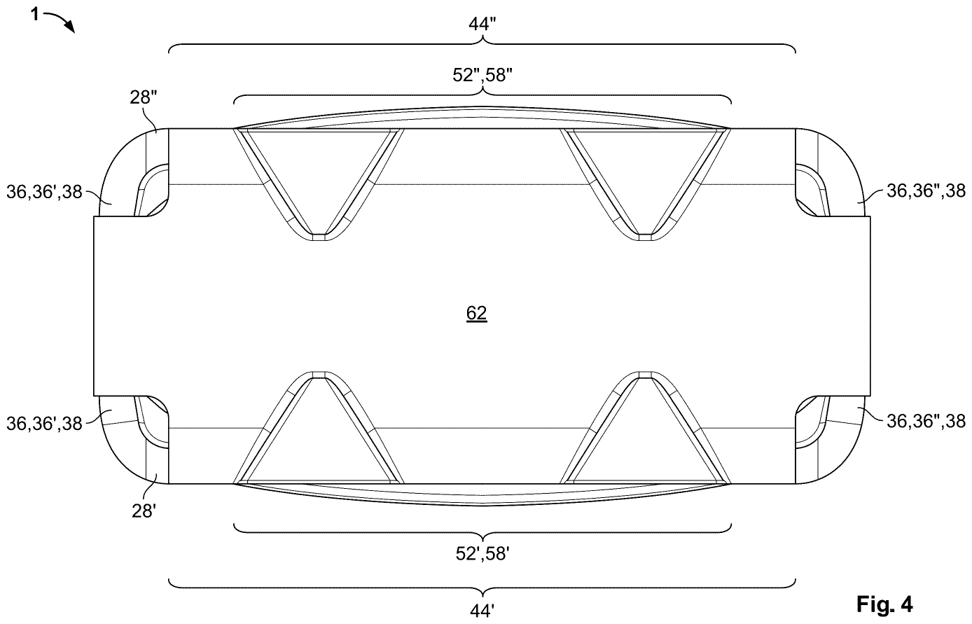

FIG. 4 shows that the first curved region 52′, in particular the first punched section 58′, as well as the second curved region 52″, in particular the second punched section 58″, each form an over-hang from the base section 62.

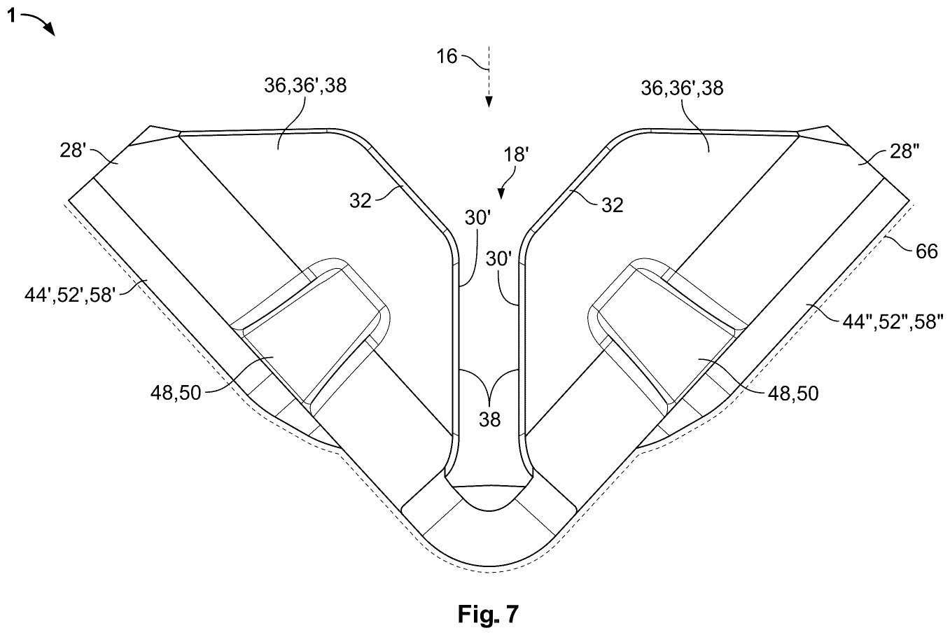

As an alternative to the embodiment shown in FIG. 6, the first and second support wall 28′, 28″ may be interconnected directly without any base section in between them (see FIG. 7). In other words, the electrical terminal 1 may rather comprise a V-shaped profile 66 in a plane essentially perpendicular to the longitudinal axis 8.

Before or after the insulation displacement termination of the insulated wire 14 is completed, the electrical terminal 1 can be connected to another electrical component (not shown). For this purpose, the electrical terminal 1 may comprise a joint section 68. In the shown embodiment of FIG. 1, the joint section 68 is configured as a soldering pad 70. Alternatively, the joint section 68 may also be configured as a pin-shaped contact, a socket-shaped contact, a crimp barrel, a welding pad or the like. The joint section 68 may be integrally connected with the base section 62. If there is no base section 62, the joint section 68 may also be integrally connected with the first and/or middle section 44′, 44″.

As can be seen in FIG. 5, the first and second support wall 28′, 28″ may each be substantially rectangular with four rims 72 that are pairwise adjacent to each other. One of the four rims 72 may be integrally connected to the base section 62 or the respective other support wall. The two rims 72 that are adjacent to the integrally connected rim are bent towards the respective other support wall and form the side lugs 36. The remaining rim 72 is arched away from the respective other support wall as long as the insulated wire 14 is not received in the first and second insulation displacement slot 18′, 18″.

When the insulated wire 14 is received in the first and second insulation displacement slot 18′, 18″, the connection assembly 2 shown in FIG. 8 is obtained. Herein, the insulated wire 14 is an electrical wire formed by the above-mentioned conductive core 12 and insulative layer 20. The insulative layer 20 surrounds the conductive core 12 from the outside.

In the connection assembly 2, the first and second support wall 28′, 28″ each at least partly pierce through the insulative layer 20 and each contact the conductive core 12. More specifically, it is the cutting edges 30, 30′, 30″ that pierce through the insulative layer 20 and contact the conductive core 12. Further, in the connection assembly 2, at least one of the first and second support wall 28′, 28″ of the electrical terminal 1 is at least sectionally straight. In particular, each of the first and second support wall 28′, 28″ may be at least sectionally straight in the connection assembly 2 (see FIG. 8).

That means, the initially arched support walls 28′, 28″ are straightened due to the mechanical loads ensuing the insulation displacement termination. As such, the straightened support walls 28′, 28″ can exert a greater reactive force on the conductive core 12 compared to known insulation displacement terminals (not shown) with straight, not-arched support walls that tend to arc inwardly and weaken when receiving the electrical wire.

As can further be seen in FIG. 8, the connection assembly 2 may comprise a housing 74 for accommodating the electrical terminal 1 therein. The housing 74 may comprise inner walls 76 against which the first and second support wall 28′, 28″ of the electrical terminal 1 rest. In particular, the first and second support wall 28′, 28″ may at least sectionally rest flatly against the inner walls 76 of the housing 74.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical terminal for contacting a conductive core of an insulated wire, the electrical terminal comprising:
a first and second insulation displacement slot each for at least partly receiving therein the insulated wire thus effecting insulation displacement termination of the received wire, wherein the first insulation displacement slot is spaced apart from the second insulation displacement slot; and
a first and second support wall each extending from the first insulation displacement slot to the second insulation displacement slot, wherein the second support wall is arranged opposite of the first support wall with respect to the first and second insulation displacement slot;
and wherein at least one of the first and second support wall is at least sectionally arched away from the respective other support wall.

2. Electrical terminal according to claim 1, wherein each of the first and second support wall is at least sectionally arched outwards and away from the respective other support wall.

3. Electrical terminal according to claim 1, wherein the first and second support wall are configured symmetrical with respect to the first and second insulation displacement slot.

4. Electrical terminal according to claim 1, wherein the first support wall comprises a first punched section and/or the second support wall comprises a second punched section, wherein the first support wall is arched at the first punched section and/or the second support wall is arched at the second punched section.

5. Electrical terminal according to claim 4, wherein the first punched section is arranged centrally on the first support wall and/or the second punched section is arranged centrally on the second support wall.

6. Electrical terminal according to claim 1, wherein the electrical terminal comprises a base section interconnecting the first and second support wall.

7. Electrical terminal according to claim 6, wherein the first and second support wall each extends at an angle to the base section.

8. Electrical terminal according to claim 1, wherein the first and second support wall each comprise a first cutting edge and a second cutting edge, wherein the first cutting edge of the first support wall and the first cutting edge of the second support wall form the first insulation displacement slot, and wherein the second cutting edge of the first support wall and the second cutting edge of the second support wall form the second insulation displacement slot.

9. Electrical terminal according to claim 8, wherein the first support wall comprises a first side lug forming its first cutting edge and a second side lug forming its second cutting edge, wherein the second support wall comprises a first side lug forming its first cutting edge and a second side lug forming its second cutting edge, wherein the first side lug of the first side wall and the first side lug of the second side wall are bent towards the first insulation displacement slot, and wherein the second side lug of the first support wall and the second side lug of the second support wall are bent towards the second insulation displacement slot.

10. Electrical terminal according to claim 9, wherein the electrical terminal comprises at least one stiffening bead extending in a bend between one of the side lugs and the rest of its corresponding support wall.

11. Electrical terminal according to claim 9, wherein the electrical terminal comprises a plurality of stiffening beads each extending in a different bend between one of the side lugs and the rest of its corresponding support wall.

12. Electrical terminal according to claim 11, wherein the first support wall comprises a first punched section and/or the second support wall comprises a second punched section, wherein the first support wall is arched at the first punched section and/or the second support wall is arched at the second punched section, and wherein the stiffening beads located on the first support wall form an arc with the first punched section, and wherein the stiffening beads located on the second support wall form an arc with the second punched section.

13. Connection assembly comprising:
an insulated wire formed by a conductive core surrounded by an insulative layer; and
an electrical terminal including a first and second insulation displacement slot each for at least partly receiving therein the insulated wire thus effecting insulation displacement termination of the received wire, wherein the first insulation displacement slot is spaced apart from the second insulation displacement slot, the electrical terminal including a first and second support wall each extending from the first insulation displacement slot to the second insulation displacement slot, wherein the second support wall is arranged opposite of the first support wall with respect to the first and second insulation displacement slot, wherein at least one of the first and second support wall is at least sectionally arched away from the respective other support wall;
wherein the insulated wire is at least partly received in the first and second insulation displacement slot, and wherein the first and second support wall each at least partly pierce through the insulative layer and contact the conductive core.

14. Connection assembly according to claim 13, wherein at least one of the first and second support wall of the electrical terminal is at least sectionally straight.

15. Connection assembly according to claim 13, wherein the connection assembly comprises a housing for accommodating the electrical terminal therein, wherein the first and second support wall of the electrical terminal at least sectionally rest flatly against inner walls of the housing.

16. Connection assembly according to claim 13, wherein each of the first and second support wall is at least sectionally arched outwards and away from the respective other support wall.

17. Connection assembly according to claim 13, wherein the first and second support wall are configured symmetrical with respect to the first and second insulation displacement slot.

18. Connection assembly according to claim 13, wherein the first support wall comprises a first punched section and/or the second support wall comprises a second punched section, wherein the first support wall is arched at the first punched section and/or the second support wall is arched at the second punched section.

19. Connection assembly according to claim 13, wherein the electrical terminal comprises a base section interconnecting the first and second support wall.

20. Connection assembly according to claim 13, wherein the first and second support wall each comprise a first cutting edge and a second cutting edge, wherein the first cutting edge of the first support wall and the first cutting edge of the second support wall form the first insulation displacement slot, and wherein the second cutting edge of the first support wall and the second cutting edge of the second support wall form the second insulation displacement slot.
